(19) United States
(12) Patent Application Publication
(10) Pub. No.: US 2006/0049696 A1
(43) Pub. Date: Mar. 9, 2006

(54) Multi-functional thermoelectric cooling and warming device

(76) Inventors: Leh Li Ju, Tau Yuan Hsien (TW); Tsung Jung Tsai, Tau Yuan Hsien (TW)

Correspondence Address: Leh Li Ju, P.O. BOX 10-69, Chung-Ho, Taipei, 235, TW

(21) Appl. No.: 10/936,405

(22) Filed: Sep. 9, 2004

(51) Int. Cl. H02M 1/00; H01H 9/30

(52) U.S. Cl. 307/151

(57) ABSTRACT

A multi-functional thermoelectric cooling and warming device comprises a receiving box; a DC power input end extended with a DC power wire; an AC power output end for outputting AC power converted from the DC power input end so as to supply AC power to an external device; a switch for selecting a cooling operation mode or a warming operating mode. The DC power input end of the receiving box is connected to a battery through the power wire. The DC power input end is directly connected to the receiving box or is plugged into the receiving box. The AC power output end is connected to an external device. The switch has three operation modes which are cooling mode, warming mode and off mode. LED lamps are installed beside the switch for showing the operation modes.

### FIELD OF THE INVENTION

The present invention relates to cooling and warming devices, and particular to a multi-functional thermoelectric cooling and warming device, which has a receiving box, a DC power input end and an AC power output end. The power can be converted from DC to AC so as to be provided to an external device.

### BACKGROUND OF THE INVENTION

In the prior art, coolers, warmers, and power converters are independently manufactured. No cooler or warmer has the function of providing AC power. The user must buy the devices independently. However, this makes troubles to users. If necessary, the user takes them independently so that the burden is heavy. If some of them are forgot to be carried out, it will feel inconveniently to users. Furthermore, the wires are complicated so that the arrangement is complex. It makes the vehicle carries the devices become disorder.

### SUMMARY OF THE INVENTION

Accordingly, the primary object of the present invention is to provide a multi-functional thermoelectric cooling and warming de vice which comprises a receiving box; a DC power input end extended with a DC power wire; an AC power output end for outputting AC power converted from the DC power input end so as to supply power to external device; and a switch for selecting a cooling operation mode or a warming operating mode.

Moreover, the DC power input end of the receiving box is connected to a battery through the power wire. The DC power input end is directly connected to the receiving box or is plugged into the receiving box.

Furthermore, the AC power output end is connected to an external device. The switch has three operation stages which are cooling mode, warming mode and off mode.

Besides, LED lamps are installed beside the switch for showing the operation modes.

The various objects and advantages of the present invention will be more readily understood from the following detailed description when read in conjunction with the appended drawing.

### BRIEF DESCRIPTION OF THE DRAWINGS

FIG. 1 is a schematic view about the DC power input end and AC power output end of the present invention.

FIG. 2 is a schematic view about the switch arrangement of the present invention.

FIG. 3 is a schematic view about the connection of the receiving box and the battery of the present invention.

FIG. 4 is a schematic view showing the connection of the receiving box with the notebook computer according to the present invention.

FIG. 5 shows the circuit block diagram of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

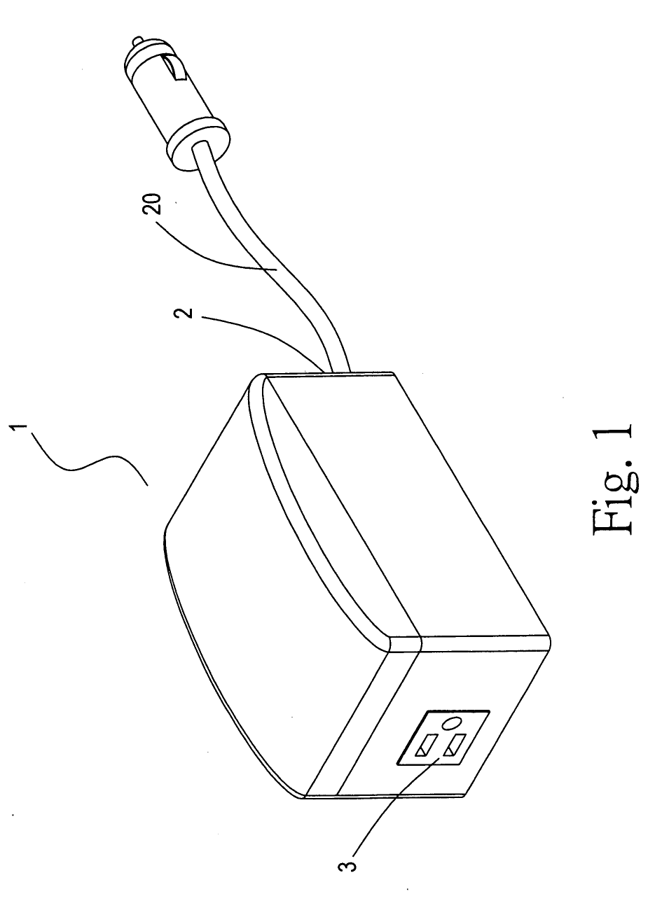

Referring to FIG. 1, the multi-functional thermoelectric cooling and warming device of the present invention is illustrated. The structural schematic views of the DC input end and AC output end are illustrated. The receiving box 1 has the following elements.

A DC power input end 2 is extended with a DC power wire 20.

An AC power output end 3 serves for outputting AC power converted from the DC power input end 2 so as to supply power to external device. Thus, no any external transformer is necessary.

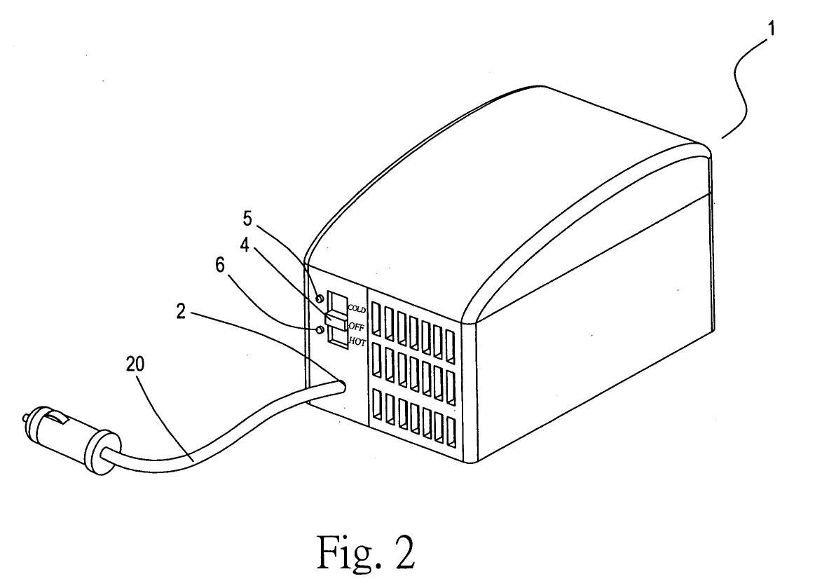

A switch 4 serves for selecting a cooling operation mode or a warming operating mode, see FIG. 2. The switch 4 has three operation modes which are cooling mode, warming mode and off mode. If the receiving box 1 is not used, the switch 4 is in the off mode. Thereby, the receiving box 1 has the operation of cooling, warming and turning-off.

LED lamps 5 and 6 are installed beside the switch 4 for showing the operation modes.

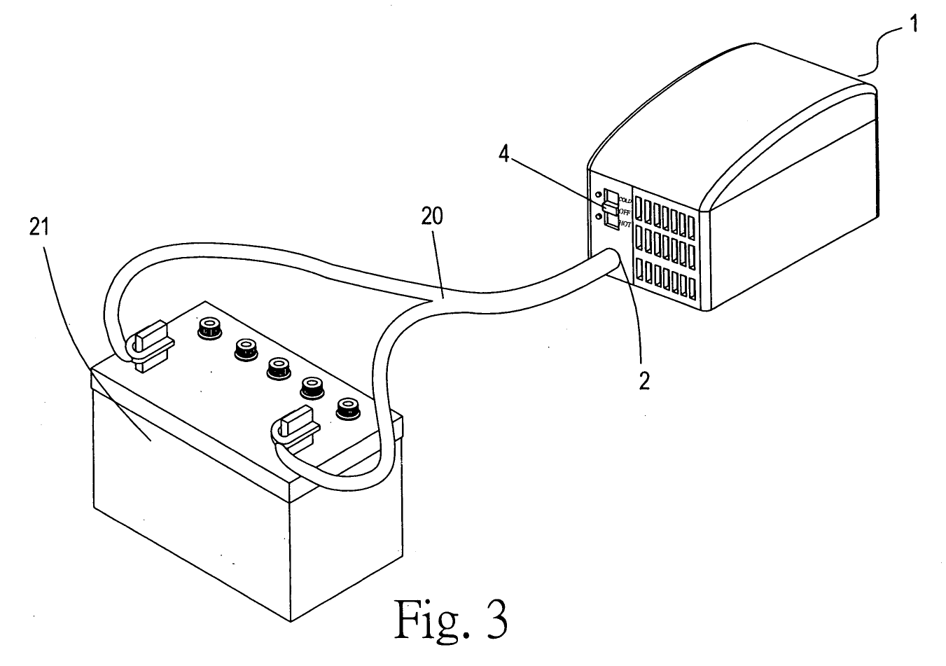

With reference to FIG. 3, a schematic view showing the embodiment of the receiving box 1 of the present invention is connected to a battery 21 (or a vehicle cigar-lighter) through the power wire 20.

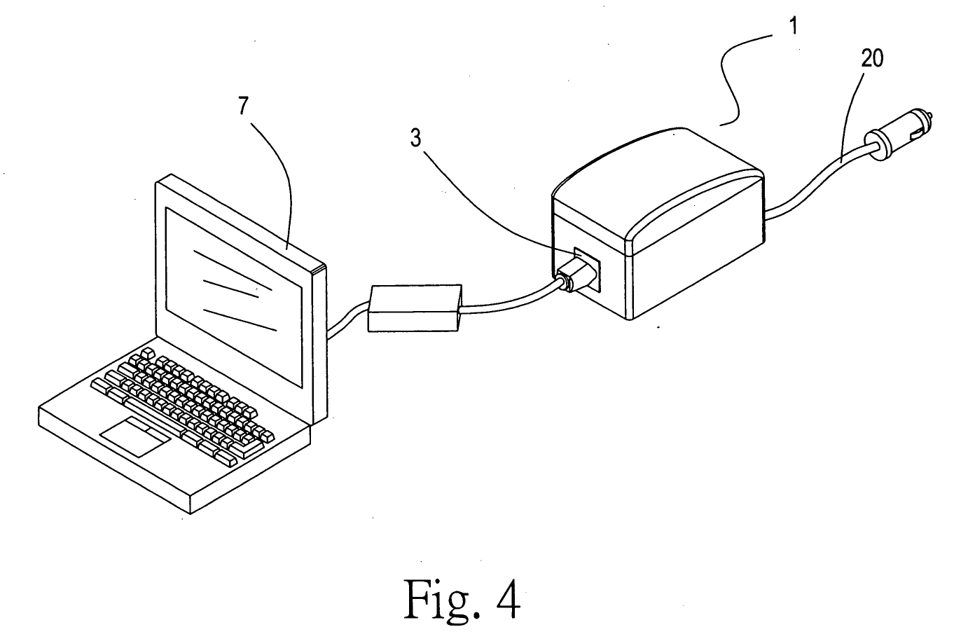

With reference to FIG. 4, it is illustrated that in the present invention, the DC power wire 20 extends from the receiving box 1. DC power is converted into AC power and then the AC power is transferred to the AC power output end 3 for supplying AC power to an external notebook computer 7. Thereby, the AC power is used.

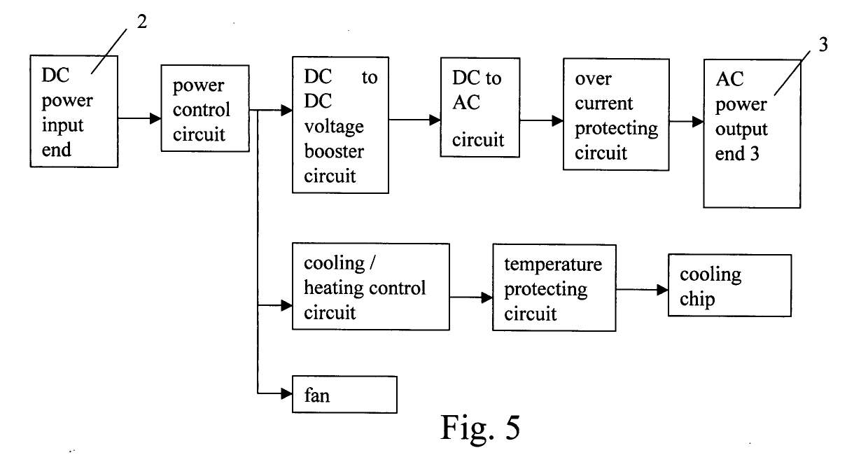

With reference to FIG. 5, the circuit block diagram of the present invention is illustrated. It is illustrated that in the present invention, The DC power input end 2 is connected to a power control circuit and then to a DC to DC voltage booster circuit, and then to a DC to AC circuit and then to an over current protecting circuit and then to an AC power output end 3. Moreover, in the present invention, the power control circuit is also connected to a cooling/heating control circuit and then to a temperature protecting circuit and then to a cooling chip. Moreover, the power control circuit is also connected to a fan.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-functional thermoelectric cooling and warming device comprising:
a receiving box;
a DC power input end connected to the receiving box and extended with a DC power wire;
an AC power output end connected to the receiving box for outputting AC power converted from DC power outputted from the DC power input end so as to supply AC power to an external device;
a switch on the receiving box for selecting a cooling operation mode or a warming operating mode.

2. The multi-functional thermoelectric cooling and warming device as claimed in claim 1, wherein the DC power input end of the receiving box is connected to a battery or a vehicle cigar-lighter through the power wire.

3. The multi-functional thermoelectric cooling and warming device as claimed in claim 1, wherein the DC power input end is directly connected to the receiving box or is plugged into the receiving box.

4. The multi-functional thermoelectric cooling and warming device as claimed in claim 1, wherein the AC power output end is connected to an external device.

5. The multi-functional thermoelectric cooling and warming device as claimed in claim 1, wherein the switch has three operation modes which are cooling mode, warming mode and off mode.

6. The multi-functional thermoelectric cooling and warming device as claimed in claim 1, wherein LED lamps are installed beside the switch for showing the operation modes.
